(19) United States
(12) Patent Application Publication
(10) Pub. No.: US 2022/0203349 A1
(43) Pub. Date: Jun. 30, 2022

(54) EVAPORATION COMPENSATION IN A FLUIDIC DEVICE

(71) Applicant: HEWLETT-PACKARD DEVELOPMENT COMPANY, L.P., Spring, TX (US)

(72) Inventors: Jeffrey A. NIELSEN, Corvallis, OR (US); Roberto A. PUGLIESE, Corvallis, OR (US)

(73) Assignee: HEWLETT-PACKARD DEVELOPMENT COMPANY, L.P., Spring, TX (US)

(21) Appl. No.: 17/607,309

(22) PCT Filed: Jul. 31, 2019
(86) PCT No.: PCT/US2019/044333

§ 371 Date: Oct. 28, 2021

(51) Int. Cl. B01L 3/02; B01L 3/00; G01N 35/10

(52) U.S. Cl. CPC B01L 3/0268; B01L 3/5085; G01N 2035/1041; B01L 2200/14; G01N 2035/1025; G01N 35/1009

(57) ABSTRACT

Aspects of the present disclosure relate to evaporation compensation in fluidic devices. An example apparatus for evaporation compensation includes an assessment circuit to determine an amount of evaporation of a volume dispensed in a microwell of a fluidic device. The amount of evaporation may be determined based on the volume in the microwell, and an amount of time after dispensing the volume in the microwell. A compensation circuit may determine, based on the amount of evaporation, a compensation factor for the microwell including an amount of a normalizing fluid to compensate for the amount of evaporation. The compensation circuit may also create a normalization profile for the fluidic device, including an association between the fluidic device and the compensation factor. A dispensing circuit may dispense the normalizing fluid in the microwell according to the normalization profile.

### BACKGROUND

Microfluidic systems enable fluid-based experiments to be conducted using much smaller quantities of fluid as compared to microtiter plate-based experiments. These small volumes enable advantages such as a reduction in expensive chemicals used, a reduction in the amount of patient sample needed which makes sample collection easier and less intrusive, a reduction in the amount of waste generated, and in some cases a reduction in the time for processing, such as temperature cycling of a sample.

### BRIEF DESCRIPTION OF FIGURES

Various examples may be more completely understood in consideration of the following detailed description in connection with the accompanying drawings, in which:

FIG. 1A illustrates an example apparatus for evaporation compensation in a fluidic device, consistent with the present disclosure;

FIGS. 1B and 1C illustrate exploded views of a cassette for evaporation compensation in a fluidic device, consistent with the present disclosure;

FIG. 2 is a diagram illustrating an example computing apparatus for evaporation compensation in a fluidic device, consistent with the present disclosure; and

FIG. 3 is a flow chart illustrating an example method for evaporation compensation in a fluidic device, in accordance with the present disclosure.

While various examples discussed herein are amenable to modifications and alternative forms, aspects thereof have been shown by way of example in the drawings and will be described in detail. It should be understood, however, that the intention is not to limit the disclosure to the particular examples described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

The life sciences research and diagnostics industries are under pressure to reduce costs, increase throughput, and improve the utilization of patient samples. As a result, the instruments and tools used therein are moving from complex macrofluidic-based systems to simpler microfluidic-based technology, moving from pipetting-based technology to dispensing-based technology, and moving from performing a single test per sample to performing multiplexed tests per sample.

Inkjet-based systems can start with microliters of fluid and then dispense picoliters or nanoliters of fluid into specific locations on a substrate. These dispense locations can be either specific target locations on the substrate surface or can be cavities, microwells, channels, or indentations into the substrate. As used herein, a microwell refers to or includes a column capable of storing a volume of fluid between a nanoliter and several milliliters of fluid. There may be tens, hundreds, or even thousands of dispense locations on the substrate, which may represent many tests on a small number of samples, a small number of tests on many samples, or a combination of the two. Additionally, multiple dispensing nozzles or print heads may dispense fluid on the substrate at a time to enable a high-throughput design. As the number of dispense locations can be 100s or 1000s of times the number of active dispensing nozzles or print heads, the time between the dispensing of the first and last wells in the substrate can be many seconds or even many minutes. Based on the difference in the amount of elapsed time between dispensing and testing, the amount of fluid in the first wells may be less than the amount of fluid in the last wells.

In accordance with examples of the present disclosure, an apparatus including an assessment circuit, a compensation circuit, and a dispensing circuit may compensate for varied evaporation among microwells on a substrate. The assessment circuit may determine an amount of evaporation of a volume dispensed in a microwell of a fluidic device; where the amount of evaporation is determined based on the volume in the microwell, and an amount of time after dispensing the volume in the microwell. The compensation circuit may determine, based on the amount of evaporation, a compensation factor for the microwell including an amount of a normalizing fluid to compensate for the amount of evaporation. The compensation circuit may also create a normalization profile for the fluidic device, including an association between the fluidic device and the compensation factor. The dispensing circuit may dispense the normalizing fluid in the microwell according to the normalization profile.

In an additional example, a non-transitory computer-readable storage medium storing instructions that, if executed, may cause a processor to compensate for evaporation in a fluidic device. The instructions may cause the processor to identify a type of fluidic device received by a test system, and a test protocol associated with the fluidic device. Further instructions may cause the processor to determine, for each microwell among a plurality of microwells in the fluidic device, an amount of evaporation of a volume dispensed in the respective microwell, based on the volume in the respective microwell, and an amount of time after dispensing the volume in the respective microwell. Additional instructions, when executed, may cause the processor to determine, for each microwell among the plurality of microwells, a compensation factor for the respective microwell including an amount of a normalizing fluid to compensate for the amount of evaporation. A normalization profile may be created for the fluidic device, including an association between the type of fluidic device and the compensation factors for the plurality of microwells, and the processor may dispense the normalizing fluid in the plurality of microwells and according to the normalization profile.

In further examples, a method for evaporation compensation in a fluidic device includes estimating for each microwell among a plurality of microwells in a fluidic device, an amount of evaporation of a volume dispensed in the respective microwell, based on the volume in the respective microwell, and an amount of time after dispensing the volume in the respective microwell. A compensation factor for each respective microwell may be determined, including an amount of a normalizing fluid to compensate for the amount of evaporation. Moreover, a normalization profile may be identified for the fluidic device, including an association between the fluidic device and the compensation factors for the plurality of microwells, and the normalizing fluid may be dispensed in the plurality of microwells and according to the normalization profile.

In the following description various specific details are set forth to describe specific examples, with the understanding that other examples may be practiced without all the specific details given below and that features from figures/examples can be combined with features of another figure or example even though the combination is not explicitly shown or explicitly described as a combination. For ease of illustration, the same reference numerals may be used in different diagrams to refer to the same elements or additional instances of the same element.

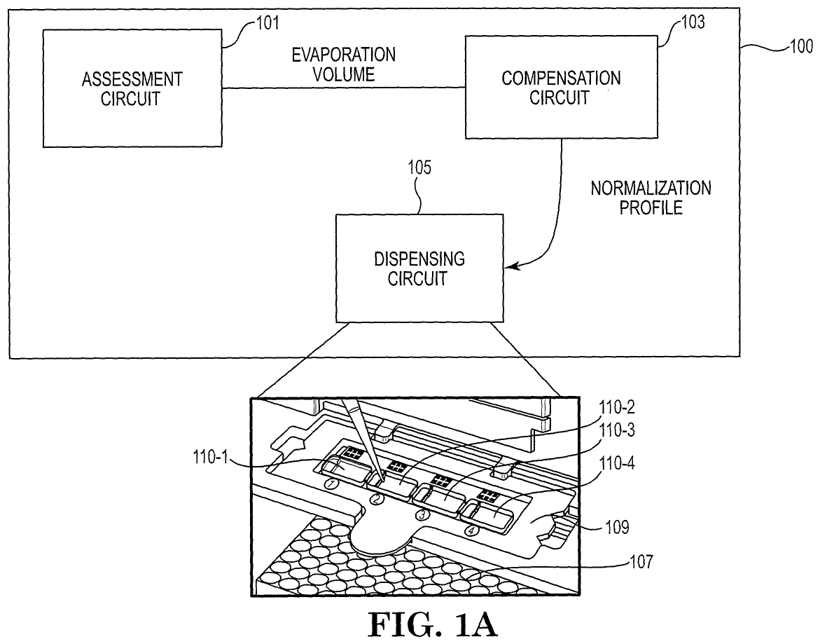

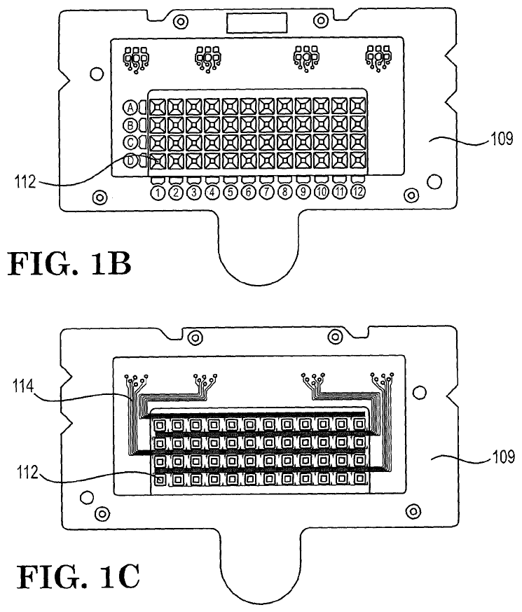

Turning now to the Figures, FIG. 1A illustrates an example apparatus 100 for evaporation compensation in a fluidic device, consistent with the present disclosure. In order to compensate for evaporation, the apparatus 100 may determine how much evaporation occurs during a dispense operation. As described herein, a fluidic device 107 (also referred to as a microfluidic device) may include a substrate or plate and a plurality of channels, indentations, and/or microwells. Each microwell of the fluidic device 107 may hold somewhere between a nanoliter and several milliliters of liquid. Because the number of dispense locations can be 100s or 1000s of times the number of active dispensing nozzles or print heads, the time between the dispensing of the first and last wells in the fluidic device 107 may be many seconds or even many minutes. Therefore, the resultant amount of fluid in the first wells may be less than the amount of fluid in the last wells due to evaporation.

In accordance with the present disclosure, the apparatus 100 may include an assessment circuit 101 to determine an amount of evaporation of a volume dispensed in a microwell of a fluidic device 107. The amount of evaporation, or evaporation volume, is determined based on the volume in the microwell, and an amount of time after dispensing the volume in the microwell. This can be done either via evaporation modeling or via empirical measurement. In fluidic devices used for diagnostics, the same filling operation and sequence may be used repeatedly and consistently. Thus, if evaporation is characterized for a particular fluidic device and a particular protocol, then a consistent normalization profile can be applied to that device for future protocols.

A compensation circuit 103 may determine, based on the amount of evaporation, a compensation factor for the microwell including an amount of a normalizing fluid to compensate for the amount of evaporation. The compensation factor may be applied to the original protocol to create an adjusted protocol. One adjustment may be to dispense more fluid into the first well and less fluid into the last well (and a range of dispense volumes in between). However, a system that does this may end up with the same amount of fluid in all wells but will have a higher concentration of the chemicals or sample of interest in the first well and a lower concentration in the last well. The compensation circuit 103 may also create a normalization profile for the fluidic device 107, including an association between the fluidic device and the compensation factor. A dispensing circuit 105 may dispense the normalizing fluid in the microwell according to the normalization profile.

In some examples, the volume dispensed in the microwell of the fluidic device 107 may include a test sample. The dispensing circuit 105 may further include a test sample dispensing circuit to dispense the test sample in the microwell and a normalization dispensing circuit (not illustrated) to dispense the normalization fluid in the microwell according to the normalization profile.

As described herein, a normalizing fluid may be added to the microwell(s) to compensate for the amount of evaporation in the associated microwell. While the first volume may contain a test sample and/or various chemicals associated with operation of the fluidic device 107, the normalizing fluid refers to or includes a fluid that does not contain a test sample or chemicals associated with operation of the fluidic device. Non-limiting examples of normalizing fluid include buffer, saline, oil, and Master Mix. In some examples, the normalizing fluid may be neat water or solvent. Additionally and/or alternatively, the normalizing fluid may include complimentary components to help the jetting or to minimize the evaporation of the test sample, such as surfactants, humectants, or viscosity agents, such as glycerol. In some examples, the same normalizing fluid can be used to normalize more than one test fluid. Moreover, the drop volume of the normalizing fluid may be different than the drop volume of the test fluid, based on the design of the resistors, bores and firing chambers of the dispensing device filling the microwells.

In some examples, the apparatus 100 includes two fluids and two or more nozzles capable of dispensing these two fluids. For instance, using a cassette 109 including a plurality of fluid ejectors, the fluids may be ejected into or onto the fluidic device 107. The cassette may include one or more pieces of Silicon. Additionally, a plurality of fluids, each fed with different reservoirs, slots, and/or fluidic paths, may be dispensed via cassette 109. As an illustration, the cassette 109 may include one piece of silicon that may be fed by two or more fluids via multiple reservoirs (110-1, 110-2, 110-3, and 110-4), such as test sample and a normalizing fluid. For instance, reservoir 110-1 may dispense a test sample, and reservoir 110-2 may dispense a normalizing fluid. Additionally and/or alternatively, there may be separate and discrete pieces of silicon with different respective fluid ejectors for each fluid to be ejected by apparatus 100. For instance, referring to FIG. 1A, cassette 109 may include a plurality of fluid ejectors for dispensing a first fluid, and a separate cassette (not illustrated in FIG. 1A) may dispense a second fluid.

The cassette 109, or multiple cassettes as the case may be, may each include a plurality of reservoirs (111-1, 111-2, 111-3, and 111-4) which provide fluid to a plurality of fluid ejectors (or nozzles). Using apparatus 100, the cassette 109 may move to different locations, rows, and/or columns of the fluidic device 107 to dispense the associated fluid. For instance, as illustrated in FIG. 1A, the fluidic device 107 may be a microwell plate, and the fluid ejectors in cassette 109 may dispense fluid into each of the wells within the microwell plate illustrated. Additionally and/or alternatively, the fluidic device 107 may be a microfluidic chip or other substrate, as described herein.

FIG. 1B and FIG. 1C illustrate exploded views of a cassette for evaporation compensation in a fluidic device, consistent with the present disclosure. FIG. 1B illustrates the top side of the cassette, such as 109 illustrated in FIG. 1A, in which fluid is filled from reservoirs (such as reservoirs 110-1, 110-2, 110-3, and 110-4 illustrated in FIG. 1A). In the example illustrated in FIG. 1B, the cassette 109 includes four (4) rows of twelve (12) fluid ejectors 112, which may in some examples may be thermal inkjet (TIJ) resistors. Above each of the ejectors 112, a reservoir (such as reservoirs 110-1, 110-2, 110-3, and 110-4 illustrated in FIG. 1A) may provide the fluid for dispensing. For instance, each of the ejectors 112 in columns 1, 2, and 3 may be provided fluid by reservoir 110-1, each of the ejectors 112 in columns 4, 5, and 6 may be provided fluid by reservoir 110-2, and so forth. Additionally and/or alternatively, each ejector 112 may be provided fluid independent of the other ejectors 112. For instance, ejector 1-D (column 1, row D) may be provided a first fluid for dispensing into/onto fluidic device 107, ejector 2-C (column 2, row C) may be provided a second fluid for dispensing into/onto fluidic device 107, and ejector 12-B (column 12, row B) may be provided a third fluid for dispensing into/onto fluidic device 107.

FIG. 1C illustrates the bottom side of the cassette, which ejects the fluid into or onto the fluidic device 107. As illustrated in FIG. 1B, each row of fluid ejectors 112 may be connected to the other rows and columns of fluid ejectors by electrical traces 114, such that firing of the fluid ejectors, and therefor ejection of the respective fluids, may be coordinated.

In some examples, the compensation circuit 103 may determine a compensation factor for a particular assay performed by the fluidic device. For instance, a particular cartridge may be placed in the apparatus 100 and a particular assay to be performed may be detected. Based on the identification of the cartridge and/or assay to be performed, the apparatus 100 may estimate an amount of evaporation for each well in the fluidic device 107 for the particular assay. Additionally, the amount of evaporation may be determined based on the size of the fluidic device 107, including a number of microwells on the fluidic device 107 and/or a number of the microwells being utilized for the particular assay. As such, the compensation circuit 103 may determine a compensation factor for the microwell(s) including an amount of a normalizing fluid to compensate for the amount of evaporation for a particular type of fluidic device and/or the particular assay to be performed.

Additionally, various normalization profiles may be stored by the apparatus 100 for subsequent retrieval and implementation. For instance, the apparatus 100 may include a memory (not illustrated in FIG. 1). The memory 100 may store normalization profiles determined by the compensation circuit. In response to identifying a particular device and/or assay, and a normalization profile associated with the identified device or assay, the apparatus 100 may use the assessment circuit 101 to retrieve the normalization profile from the memory in response to identification of the fluidic device. The dispensing circuit 105 may dispense the normalization fluid in response to retrieval of the normalization profile from the memory.

Evaporation compensation in fluidic devices, in accordance with the present disclosure, may improve the number of wells dispensed to within volumetric accuracy and or sample concentration specification.

In some examples, the spacing between sample nozzles and normalization nozzles matches the spacing between microwells on the fluidic device. This may allow for simultaneous dispensing of test fluid and normalization fluid, albeit into different wells. This enables the normalization to take place without additional time for dispensing.

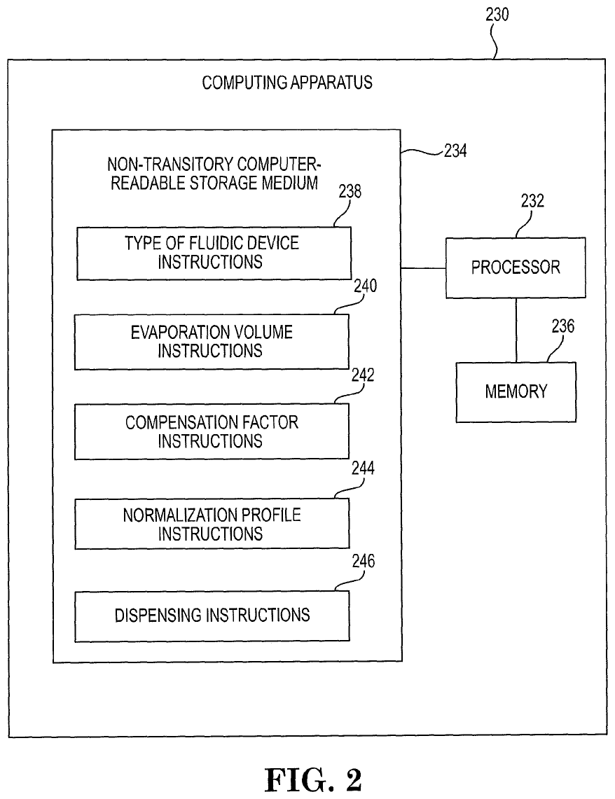

FIG. 2 is a diagram illustrating an example computing apparatus for evaporation compensation in a fluidic device, consistent with the present disclosure. In the example of FIG. 2, the computing apparatus 230 may include a processor 232 and a non-transitory computer-readable storage medium 234, and a memory 236. The non-transitory computer-readable storage medium 234 further includes instructions 238, 240, 242, 244, and 246 for evaporation compensation in a fluidic device. The computing apparatus 230 may be, for example, a printer, a mobile device, multimedia device, a secure microprocessor, a notebook computer, a desktop computer, an all-in-one system, a server, a network device, a controller, a wireless device, or any other type of device capable of executing the instructions 238, 240, 242, 244, and 246. In certain examples, the computing apparatus 230 may include or be connected to additional components such as memory, controllers, etc.

The processor 232 may be a central processing unit (CPU), a semiconductor-based microprocessor, a graphics processing unit (GPU), a microcontroller, special purpose logic hardware controlled by microcode or other hardware devices suitable for retrieval and execution of instructions stored in the non-transitory computer-readable storage medium 234, or combinations thereof. The processor 232 may fetch, decode, and execute instructions 238, 240, 242, 244, and 246 to compensate for evaporation in a fluidic device, as discussed with regards to FIG. 1. As an alternative or in addition to retrieving and executing instructions, the processor 232 may include at least one integrated circuit (IC), other control logic, other electronic circuits, or combinations thereof that include a number of electronic components for performing the functionality of instructions 238, 240, 242, 244, and 246.

Non-transitory computer-readable storage medium 234 may be an electronic, magnetic, optical, or other physical storage device that contains or stores executable instructions. Thus, non-transitory computer-readable storage medium 234 may be, for example, Random Access Memory (RAM), an Electrically Erasable Programmable Read-Only Memory (EEPROM), a storage device, an optical disc, etc. In some examples, the computer-readable storage medium 234 may be a non-transitory storage medium, where the term ‘non-transitory’ does not encompass transitory propagating signals. As described in detail below, the non-transitory computer-readable storage medium 234 may be encoded with a series of executable instructions 238, 240, 242, 244, and 246. In some examples, non-transitory computer-readable storage medium 234 may implement a memory 236 to store and/or execute instructions 238, 240, 242, 244, and 246. Memory 236 may be any non-volatile memory, such as EEPROM, flash memory, etc.

In various examples, the non-transitory computer-readable storage medium 234 stores instructions 238 that, if executed, cause the processor 232 to identify a type of fluidic device received by a test system, and a test protocol associated with the fluidic device. For instance, the computing apparatus 230 may receive information identifying a type of fluidic device to be used for fluid dispensing. The fluidic device may include a plate or substrate including a plurality of microwells. Additionally, a cartridge or other component may be received and/or identified. Similarly, a type of protocol and/or assay to be performed may be identified. The type of assay and/or protocol may be identified based on the identification of the type of fluidic device, by manual input, or by other means.

The evaporation instructions 240, when executed by the processor 232, may cause the processor 232 to determine, for each microwell among a plurality of microwells in the fluidic device, an amount of evaporation of a volume dispensed in the respective microwell. The amount of evaporation may be based on the volume in the respective microwell, and an amount of time after dispensing the volume in the respective microwell. For instance, referring to FIG. 1, the apparatus 100 may identify a cartridge and microwell plate received in the apparatus 100. The apparatus 100 may further identify a size of the microwell plate. For instance, the apparatus 100 may identify whether the fluidic device, or microwell plate in this illustration, has 6, 12, 24, 48, 96, 384 or 1536 microwells.

The compensation factor instructions 242, when executed by the processor 232, may cause the processor 232 to determine, for each microwell among the plurality of microwells, a compensation factor for the respective microwell including an amount of a normalizing fluid to compensate for the amount of evaporation. For example, if the fluidic device includes 1536 microwells, an amount of evaporation may be determined for each of the 1536 microwells. Similarly, a compensation factor may be identified for each of the 1536 microwells. In some examples, the compensation factor may be a same volume of normalizing fluid for a row or microwells. In some examples, the compensation factor may be a gradient of normalizing fluid from the first microwell to the last microwell. Yet further, the compensation factor may be different for each respective microwell.

The compensation factor or compensation factors identified for the particular fluidic device, may be used to create a normalization profile for the fluidic device. As such, the normalizing profile instructions 244, when executed by the processor 232, may cause the processor to create a normalizing profile for the fluidic device, including an association between the type of fluidic device and the compensation factors for the plurality of microwells. For instance, if the fluidic device is a plate with 1536 microwells for performing polymerase chain reaction (PCR), the normalization profile would include compensation factors for the 1536 microwells to compensate for evaporation of fluid in the microwells prior to performing PCR. As a further illustration, if the fluidic device is a substrate including a plurality of channels, the normalization profile would include compensation factors for the plurality of channels prior to performing an assay using the plurality of channels. The dispensing instructions 245, when executed by the processor 232, may cause the processor to dispense the normalizing fluid in the plurality of microwells and according to the normalization profile.

In various examples, the computing apparatus 230 further includes instructions that, if executed, cause the processor to determine the compensation factor based on the test protocol associated with the fluidic device. For instance, PCR may include a first set of reagents that evaporate at a first rate, whereas an antibody assay may include a second set of reagents that evaporate at a second rate. Accordingly, the compensation factor for PCR may differ from the compensation factor for the antibody assay. As such, the compensation factor, and therefore, the normalizing fluid applied, may differ based on the type of test protocol or assay associated with the fluidic device and/or being performed by the fluidic device. Similarly, the computing apparatus may include instructions that, if executed, cause the processor to determine the compensation factor for each respective microwell based on the test protocol associated with the fluidic device.

In some examples, the computing apparatus may further include instructions that, if executed, cause the processor to determine the compensation factor for each respective microwell based in part on a number of the microwells in the fluidic device. For instance, a longer amount of time may pass while dispensing fluid in 1536 microwells as opposed to 6 microwells. Accordingly, less evaporation may occur when dispensing fluid in 6 microwells as opposed to 1536 microwells, and therefore the compensation factor may depend in part on the number of microwells, channels, or indentations in the fluidic device.

In various examples, the computing apparatus may include instructions that, if executed, cause the processor 232 to determine the compensation factor for each respective microwell based in part on an amount of time between when the volume in a first one of the plurality of microwells is dispensed and when the volume in a last one of the plurality of microwells is dispensed. For instance, a first microwell may be a microwell in which a test sample is first dispensed in, and the last microwell may be a microwell in which the test sample is last dispensed in. The time between dispensing test sample in the first microwell and the last microwell may, in part, determine the amount of evaporation in the respective microwells, and therefore, the compensation factor for the respective microwells.

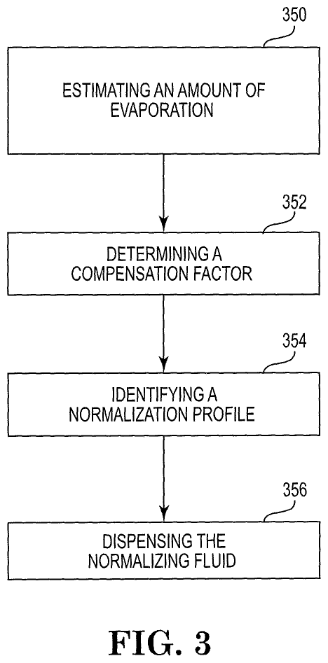

FIG. 3 is a flow chart illustrating an example method for evaporation compensation in a fluidic device, in accordance with the present disclosure. At 350, the method includes estimating an amount of evaporation. As discussed with regards to FIGS. 1 and 2, for each microwell among a plurality of microwells in a fluidic device, an amount of evaporation of a volume dispensed in the respective microwell, may be determined based on the volume in the respective microwell, and an amount of time after dispensing the volume in the respective microwell. At 352, the method includes determining a compensation factor for each respective microwell including an amount of a normalizing fluid to compensate for the amount of evaporation. At 354, the method includes identifying a normalization profile for the fluidic device, including an association between the fluidic device and the compensation factors for the plurality of microwells. At 356, the method includes dispensing the normalizing fluid in the plurality of microwells and according to the normalization profile.

As discussed herein, different types of devices and different assays and/or test protocols may be associated with different rates of evaporation and therefore different normalization profiles. Accordingly, the method may include identifying a first normalization profile for the fluidic device. The first normalization profile may include an association between the fluidic device, the compensation factors for the plurality of microwells, and a first type of protocol to be implemented with the fluidic device. Similarly, the method may include identifying a second normalization profile for the fluidic device, including an association between the fluidic device, the compensation factors for the plurality of microwells, and a second type of protocol to be implemented with the fluidic device different than the first type of protocol. As such, different assays and/or protocols may be performed using a same type of fluidic device, and therefore, different normalization profiles may be associated with the same fluidic device.

In various examples, the method includes receiving the fluidic device in a dispensing apparatus. For instance, the fluidic device may include a microplate including a matrix of microwells. Furthermore, the method may include dispensing the volume in each of the plurality of microwells using a first nozzle array of the dispensing apparatus, and dispensing the normalizing fluid in each of the plurality of microwells using a second nozzle array of the dispensing apparatus.

As discussed herein, different fluidic devices may be associated with a different respective rate of evaporation and therefore a different normalization profile. As such, the method may include, responsive to the dispensing apparatus identifying a second fluidic device, retrieving a second normalization profile for the second fluidic device from a memory of the dispensing apparatus. The method may further include dispensing a normalizing fluid in a plurality of microwells of the second fluidic device according to the second normalization profile.

The skilled artisan would recognize that various terminology as used in the Specification (including claims) connote a plain meaning in the art unless otherwise indicated. As examples, the Specification describes and/or illustrates aspects useful for implementing the claimed disclosure by way of various structure, such as circuits or circuitry selected or designed to carry out specific acts or functions, as may be recognized in the figures or the related discussion as depicted by or using terms such as device, system, and/or other examples. See, e.g., reference numerals 101, 103, and 105 of FIG. 1. It will also be appreciated that certain of these blocks may also be used in combination to exemplify how operational aspects (e.g., steps, functions, activities, etc.) have been designed, arranged. Whether alone or in combination with other such blocks (or circuitry including discrete circuit elements such as transistors, resistors etc.), these above-characterized blocks may be circuits configured/coded by fixed design and/or by (re)configurable circuitry (e.g., CPUs/logic arrays/controllers) and/or circuit elements to this end of the corresponding structure carrying out such operational aspects. In certain examples, such a programmable circuit refers to or includes one or more computer circuits, including memory circuitry for storing and accessing a set of program code to be accessed/executed as instructions and/or (re)configuration data to perform the related operation, as may be needed in the form of carrying out a single step or a more complex multi-step algorithm. Depending on the data-processing application, such instructions (and/or configuration data) can be configured for implementation in logic circuitry, with the instructions (via fixed circuitry, limited group of configuration code, or instructions characterized by way of object code, firmware and/or software) as may be stored in and accessible from a memory (circuit).

Based upon the above discussion and illustrations, those skilled in the art will readily recognize that various modifications and changes may be made to the various examples without strictly following the exemplary examples and applications illustrated and described herein. Such modifications do not depart from the true spirit and scope of various aspects of the disclosure, including aspects set forth in the claims.

What is claimed is:

1. An apparatus, comprising:
an assessment circuit to determine an amount of evaporation of a volume dispensed in a microwell of a fluidic device, wherein the amount of evaporation is determined based on the volume in the microwell, and an amount of time after dispensing the volume in the microwell;
a compensation circuit to:
determine, based on the amount of evaporation, a compensation factor for the microwell including an amount of a normalizing fluid to compensate for the amount of evaporation; and
create a normalization profile for the fluidic device, including an association between the fluidic device and the compensation factor; and
a dispensing circuit to dispense the normalizing fluid in the microwell according to the normalization profile.

2. The apparatus of claim 1, further including the compensation circuit to determine a compensation factor for the microwell including an amount of a normalizing fluid to compensate for the amount of evaporation for a particular assay performed by the fluidic device.

3. The apparatus of claim 1, further including the compensation circuit to determine a compensation factor for the microwell including an amount of a normalizing fluid to compensate for the amount of evaporation for a particular type of fluidic device.

4. The apparatus of claim 1, further including the assessment circuit to:
retrieve the normalization profile from a memory in response to identification of the fluidic device; and
dispense the normalization fluid in response to retrieval of the normalization profile from the memory.

5. The apparatus of claim 1, wherein the volume dispensed in the microwell includes a test sample, the dispensing circuit further including a test sample dispensing circuit to dispense the test sample in the microwell and a normalization dispensing circuit to dispense the normalization fluid in the microwell according to the normalization profile.

6. A non-transitory computer-readable storage medium storing instructions that, if executed, cause a processor to:
identify a type of fluidic device received by a test system, and a test protocol associated with the fluidic device;
determine, for each microwell among a plurality of microwells in the fluidic device, an amount of evaporation of a volume dispensed in the respective microwell, based on the volume in the respective microwell, and an amount of time after dispensing the volume in the respective microwell;
determine, for each microwell among the plurality of microwells, a compensation factor for the respective microwell including an amount of a normalizing fluid to compensate for the amount of evaporation;
create a normalization profile for the fluidic device, including an association between the type of fluidic device and the compensation factors for the plurality of microwells; and
dispense the normalizing fluid in the plurality of microwells and according to the normalization profile.

7. The non-transitory computer-readable storage medium of claim 6, further including instructions that, if executed, cause the processor to determine the compensation factor based on the test protocol associated with the fluidic device.

8. The non-transitory computer-readable storage medium of claim 6, further including instructions that, if executed, cause the processor to determine the compensation factor for each respective microwell based on the test protocol associated with the fluidic device.

9. The non-transitory computer-readable storage medium of claim 6, further including instructions that, if executed, cause the processor to determine the compensation factor for each respective microwell based in part on a number of the microwells in the fluidic device.

10. The non-transitory computer-readable storage medium of claim 6, further including instructions that, if executed, cause the processor to determine the compensation factor for each respective microwell based in part on the test protocol associated with the fluidic device.

11. The non-transitory computer-readable storage medium of claim 6, further including instructions that, if executed, cause the processor to determine the compensation factor for each respective microwell based in part on an amount of time between when the volume in a first one of the plurality of microwells is dispensed and when the volume in a last one of the plurality of microwells is dispensed.

12. A method, comprising:
estimating for each microwell among a plurality of microwells in a fluidic device, an amount of evaporation of a volume dispensed in the respective microwell, based on the volume in the respective microwell, and an amount of time after dispensing the volume in the respective microwell;
determining a compensation factor for each respective microwell including an amount of a normalizing fluid to compensate for the amount of evaporation;
identifying a normalization profile for the fluidic device, including an association between the fluidic device and the compensation factors for the plurality of microwells; and
dispensing the normalizing fluid in the plurality of microwells and according to the normalization profile.

13. The method of claim 12, including identifying:
a first normalization profile for the fluidic device, including an association between the fluidic device, the compensation factors for the plurality of microwells, and a first type of protocol to be implemented with the fluidic device; and
a second normalization profile for the fluidic device, including an association between the fluidic device, the compensation factors for the plurality of microwells, and a second type of protocol to be implemented with the fluidic device different than the first type of protocol.

14. The method of claim 12, including:
receiving the fluidic device in a dispensing apparatus; and
dispensing the volume in each of the plurality of microwells using a first nozzle array of the dispensing apparatus, and dispensing the normalizing fluid in each of the plurality of microwells using a second nozzle array of the dispensing apparatus.

15. The method of claim 14, including:
responsive to the dispensing apparatus identifying a second fluidic device, retrieving a second normalization profile for the second fluidic device from a memory of the dispensing apparatus; and
dispensing a normalizing fluid in a plurality of microwells of the second fluidic device according to the second normalization profile.
